(19) United States
(12) Patent Application Publication
(10) Pub. No.: US 2008/0259452 A1
(43) Pub. Date: Oct. 23, 2008

(54) RETARDATION COMPENSATION ELEMENT AND METHOD FOR MANUFACTURING THE SAME

(76) Inventor: Mototaka KANAYA, Sano-shi (JP)

Correspondence Address: BIRCH STEWART KOLASCH & BIRCH, PO BOX 747, FALLS CHURCH, VA, 22040-0747, US

(21) Appl. No.: 12/104,004

(22) Filed: Apr. 16, 2008

(30) Foreign Application Priority Data
Apr. 17, 2007 (JP) P2007-108536

(51) Int. Cl. G02B 5/30; G02B 1/08

(52) U.S. Cl. 359/499; 427/163.1

(57) ABSTRACT

Substrates 7a to 7e are held by a rotating drum 6, and a retardation compensation layer is formed by means of sputtering by releasing particles from target materials 9, 10 while rotating the drum 6. After a first unit layer corresponding to a half of the retardation compensation layer is formed, the substrates 7a to 7e are rotated 90 degrees about its normal line by rotating substrate holders 24. Then, a second unit layer corresponding to the remaining half of the retardation compensation layer is formed in the same manner.

### CROSS-REFERENCE TO RELATED APPLICATIONS

This application is based upon and claims the benefit of priority from the Japanese Patent Application No. 2007-108536 filed on Apr. 17, 2007; the entire contents of which are incorporated herein by reference.

### BACKGROUND OF THE INVENTION

1. Technical Field

The invention relates to a retardation compensation element that is used in combination with a liquid crystal display panel, and a method for manufacturing the retardation compensation element.

2. Description of the Related Art

A liquid crystal display panel has been generally used in a television set and a direct-view-type display device, and has been also used as an image display device of a liquid crystal projector. The liquid crystal display panel is formed by arranging a lot of liquid crystal cells in a predetermined pattern in accordance with pixel arrangement. There have been known various types of the liquid crystal display panel such as a TN (Twisted Nematic) type, a VAN (Vertical Alignment Nematic) type, an IPS (In-Plane Switching) type, and an OCB (Optically Compensatory Bend) type, which are distinguished based on difference of an operation mode of liquid crystal molecules sealed in the liquid crystal cells.

As to a liquid crystal display panel used in a liquid crystal projector, a panel having an excellent light-shielding ability is suitable in order to enhance contrast of an image formed on a screen. For example, there is a trend that the VAN type is widely used. In the VAN type liquid crystal display panel, most of liquid crystal molecules having a bar shape are substantially vertically aligned with respect to substrates in a non-voltage state where a voltage is not applied between the substrates sandwiching a liquid crystal layer. When a pair of polarizing plates disposed with cross nicols state is combined therewith, it is possible to obtain excellent light-shielding characteristics and it is also possible to obtain high contrast.

On the other hand, the known weakness of the liquid crystal display panel is a narrow viewing angle. For example, when liquid crystal molecules are vertically aligned in the non-voltage state of the VAN-type liquid crystal display panel, a ray vertically incident on the liquid crystal layer can be sufficiently shielded, but a ray obliquely incident on the liquid crystal molecules is birefracted in various manner in accordance with its incident angle. Therefore, generally a linearly polarized ray is changed into an elliptically polarized ray. As a result, a partial component of the polarized lay passes through the polarizing plate disposed in the cross-nicols state on an exit surface side, thereby causing contrast deterioration. Also, even if the liquid crystal molecules are horizontally aligned or diagonally aligned, it is hard to avoid deterioration in display image quality caused by birefringence difference according to an angle of the ray incident on the liquid crystal layer.

The aforementioned problems of the liquid crystal display panel can be solved by using retardation compensation elements described in JP 2006-91388 A and JP 2004-102200 A (corresponding to US 2005/0168662 A). The liquid crystal layer functions as a positive retarder in which a normal light component of the incident ray propagates faster than an abnormal light component, due to its birefringence property. Conversely, the retardation compensation element functions as a negative retarder in which the normal light component generates a phase delay with respect to the abnormal light component. Accordingly, by combining the retardation compensation element with the liquid crystal display panel, it is possible to offset birefringence against each other, and it is possible to suppress the contrast deterioration mentioned above.

As described in JP 2006-91388 A and JP 2004-102200 A, the liquid crystal projector uses a high brightness lamp as a light source. and thus the retardation compensation element requires sufficient heat resisting property. As described in JP 2006-91388 A, when the optically anisotropic crystal plate is used in the retardation compensation element, it is possible to obtain sufficient heat resisting property. However, such a crystal itself is expensive, accuracy in size and cutting of a crystal surface should be precisely managed at the time of processing, and assembling and adjustment is also difficult. In this point of view, the retardation compensation element described in JP 2004-102200 A can be constituted of multilayer films in which transparent thin layers made of inorganic material are stacked. Therefore, it is advantageous that the retardation compensation element is excellent in heat-resisting property, durability, and mass-production qualification, and can be provided with low cost.

The retardation compensation element described in JP 2004-102200 A is constituted of multilayer films in which two types of thin layers having different refractive indices from each other are alternately stacked with thicknesses which are thin so as not to cause interference under visible light. The retardation compensation element functions as a uniaxial negative c-plate in crystal optics. As to the two types of thin layers, it is possible to use various thin layers including high-reflactive-index films such as TiO₂, ZrO₂, and Nb₂O₅ and low-refractive-index films such as SiO₂, MgF₂, and CaF₂. Also, these thin layers can be manufactured by using a method of forming a multilayer film such as deposition, sputtering, and ion plating, and can be easily manufactured by, for example, a sputtering device shown in FIG. 7.

FIG. 7 is a schematic view illustrating a sputtering device for manufacturing the retardation compensation element in which the two types of thin layers made of inorganic material are alternately stacked. In the drawing, an exhaust pipe 3, an inlet nozzle 4 of discharge gas, inlet nozzles 5, 5 for introducing reaction gas are communicates with a vacuum chamber 2. In the vacuum chamber 2, a drum 6 is rotatably mounted on the circumference of a vertical supporting shaft, and transparent substrates 7 on which the thin layers are to be formed are supported by an outer peripheral surface of the drum 6. In the drawing, five substrates 7 are vertically arranged on only one surface of the flat outer peripheral surfaces of the drum 6 having an octagonal cylinder shape. However, actually, all the eight surfaces of the drum 6 support the substrates 7 in the same manner. Also, the drum 6 is formed in a desired shape such as a hexagonal cylinder shape or a circular cylinder shape so long as the substrates 7 are supported at equidistance from the rotation axis of the drum 6. Furthermore, the number of the substrates 7 supported by the outer peripheral surfaces of the drum 6 may be properly adjusted based on the size of each substrate 7 and the size of the drum 6.

In the vacuum chamber 2, two types of target materials 9, 10 are provided to face the substrates 7. These target materials 9, 10 are used as materials of the two types of thin layers, which are alternately stacked on the substrates 7. For example, Nb (niobium) and Si (silicon) may be used. Also, while the drum 6 is being rotated at a constant speed, a chemically reactive sputtering is performed on these target materials 9, 10 in oxygen atmosphere. Thereby, it is possible to obtain multilayer films formed by alternately stacking Nb₂O₅ films having a high refractive index (n=2.38) and SiO₂ films having a low refractive index (n=1.48) on the substrates 7.

When these high refractive index film and low refractive index films are stacked with a physical thickness, for example, as thin as 10 to 20 nm, it is possible to obtain the retardation compensation element (negative retarder) having birefringence Δn. Magnitude of the birefringence Δn is determined by (i) a difference in refractive index between the high refractive thin layer and the low refractive thin layer and (ii) a ratio of physical thicknesses of the thin layers, and retardation dΔn is determined by the product of the birefringence Δn by a total thickness d of the entire multilayer film. Thus, film design is changed in accordance with a value of positive retardation dΔn generated by a liquid crystal layer of an applied liquid crystal display panel. It is advantageous to alternately stack the two types of thin layers in order to simplify the film formation process, but it is also possible to obtain a similar retardation compensation effect even of three or more types of thin layers having different refractive indices from each other are combined.

As shown in FIG. 8, a retardation compensation element 20 obtained in the manner described above has a structure in which a retardation compensation layer 21 including a multilayer film is formed on a surface of a substrate 7. Also, if necessary, the retardation compensation element 20 is provided with an anti-reflection film on the rear surface of the substrate 7, the top layer of the retardation compensation layer 21, and/or the bottom layer thereof contacting with the substrate 7. When the retardation compensation element 20 is applied to the VAN type liquid crystal display panel mentioned above, for example, birefringence property can not be observed with respect to a ray P1 vertically incident on the VAN type liquid crystal layer, which is in a non-voltage state. Therefore, the retardation compensation element 20 also generates less negative retardation in the ray P1. However, in the case where a ray P2 is incident at an incident angle θ, positive retardation dΔn is generated in accordance with light path length in the liquid crystal layer when the ray P2 passes through the liquid crystal layer. Thus, in order to compensate the positive retardation dΔn, the retardation compensation element 20 generates the negative retardation dΔn.

FIG. 9 is a conoscopic graph illustrating the negative retardation dΔn generated by the retardation compensation element 20, which is manufactured by the sputtering device shown in FIG. 7, in an inclined incident light having 30 degrees in incident angle θ. As shown in a characteristic curve Q1, there is no problem when a value of the retardation dΔn is substantially constant irrespective of azimuth angles (which corresponds to an angle by which the substrate 7 is rotated about the normal line when the ray P2 is fixed in a certain direction). However, sometimes, there is a case where a retardation compensation element 20 having a value of the retardation dΔn, which varies depending on the azimuth angle like a characteristic curve Q2 is manufactured. In such the retardation compensation element 20, the retardation dΔn generated in the liquid crystal layer may not be compensated in accordance with some directions in which the liquid crystal display panel is observed, and this effect gradually increases as the value of the incident angle θ increases. Moreover, the retardation compensation element having the above trend as indicated by the characteristic curve Q2 with respect to the ray P2 generates negative retardation dΔn that is larger than 1 nm even in the vertically incident ray P1. Therefore, it is hard to obtain retardation compensation effect with high accuracy.

### SUMMARY OF THE INVENTION

The invention has been made in view of the above circumstances and improves the retardation compensation effect having the retardation compensation layer formed by stacking a lot of layers including at least two types of thin layers having different refractive indices from each other with a thickness which is thin so as not to cause interference under visible light, and to provide a method capable of effectively manufacturing the retardation compensation element in which the retardation compensation layer is formed.

In the invention, film formation conditions of the respective thin layers are not always the same when the retardation compensation layer having the aforementioned multilayer fihm structure is manufactured. The differences of the film formation conditions change physical properties of the respective thin layers. Also, employing the multilayer structure accumulates and emphasizes the change in the physical properties of the respective thin layers. Thus, the retardation compensation effect is changed. In order to achieve the object of the invention, this change is focused on. The retardation compensation layer is formed by a combination of first and second unit layers in which at least two types of thin layers are stacked, respectively, and a retardation distribution characteristic of the first unit layer for azimuth angles of an incident ray is substantially perpendicular to a retardation distribution characteristic of the second unit layer for the azimuth angles of the incident ray, thereby increasing uniformity of the retardation compensation effect with respect to, particularly, the inclined incident light.

The first unit layer and the second unit layer having the retardation distribution characteristics for the azimuth angles of the incident ray, which are substantially perpendicular to each other, may be integrally stacked on one side of the substrate. Alternatively, the first unit layer may be formed on one surface of the substrate and the second unit layer may be formed on the other surface thereof. In order to increase manufacturing efficiency, it is advantageous that a multilayer film structure that form the first unit layer and a multilayer film structure that form the second unit layer may be the same. Also, various thin-film materials may be used to form the respective thin layers. Particularly, in order to obtain stable refractive index and physical strength of the thin layers, it is suitable to use an oxide film.

In order to obtain the first unit layer and the second unit layer having the retardation distribution characteristics for the azimuth angles of the incident ray, which are substantially perpendicular to each other, it is the most simple manufacturing method in which the substrate is rotated 90 degrees while the film formation condition in the vacuum chamber is kept without variation. Even if the film formation condition in the vacuum chamber is constantly kept, practically, physical properties having directivity tend to appear in the respective formed thin layers in accordance with relative positions between the substrate and the thin-film material in the vacuum chamber. Such change in physical properties of the thin layers, which are caused by slight difference in film formation condition, can be substantially neglected for the purpose of obtaining desired optical performance in a general optical interference thin layer. However, this change is accumulated and emphasized in the retardation compensation layer having stacked thin layers number of which is in the range from several tens or one hundred several tens to several hundreds. However, when the substrate is rotated 90 degrees after the first unit layer is formed and then the second unit layer is formed, the physical properties having directivity are complementarily adjusted. Therefore, it is possible to obtain the good retardation compensation effect.

Also, in the case where the first unit layer is formed on one surface of the substrate and the second unit layer is formed on the other surface thereof, it is necessary not only to rotate the substrate about the normal line 90 degrees after the first unit layer is formed but also to invert the front and back surface of the substrate. It is preferable to rotate the substrate 90 degrees and invert the substrate surface during the sequential process of the film formation, without bringing the vacuum chamber to be the air pressure. In the manufacturing of the retardation compensation element, it is possible to use various film formation methods, and it is preferable to use a sputtering method.

According to the invention, it is possible to simply and effectively manufacture the retardation compensation element that well serves as a negative retarder. Also, according to the retardation compensation element of the invention, it is possible to improve the defective retardation compensation effect for the inclined incident light, which frequently occurs in the retardation compensation element having the multilayer film structure of the related art. Also, it is also possible to suppress retardation that occurs in the vertical incident light, to be 1 nm or less.

### BRIEF DESCRIPTION OF THE DRAWINGS

FIG. 1 is a schematic view illustrating a sputtering device for manufacturing a retardation compensation element according to the invention.

FIG. 2 is a schematic section view illustrating an example in which a retardation compensation layer is provided on one side of a substrate.

FIG. 3 is a schematic section view illustrating an example in which the retardation compensation layer is separately formed on the both side of the substrate.

FIG. 4 is a schematic section view illustrating an example of a retardation compensation element that is combined with an antireflection layer.

FIG. 5 is a graph illustrating retardation distribution characteristics for azimuth angles, of comparison samples.

FIG. 6 is a graph illustrating retardation distribution characteristics for azimuth angles, of samples of the invention.

FIG. 7 is a schematic view illustrating a sputtering device of a related art.

FIG. 8 is an explanatory view illustrating a ray incident on a retardation compensation element.

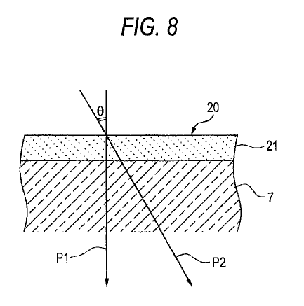

FIG. 9 is a schematic graph illustrating retardation distribution characteristics for azimuth angles, of the retardation compensation element of the related art.

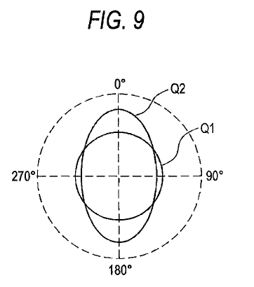

### DETAILED DESCRIPTION OF EMBODIMENTS OF THE INVENTION

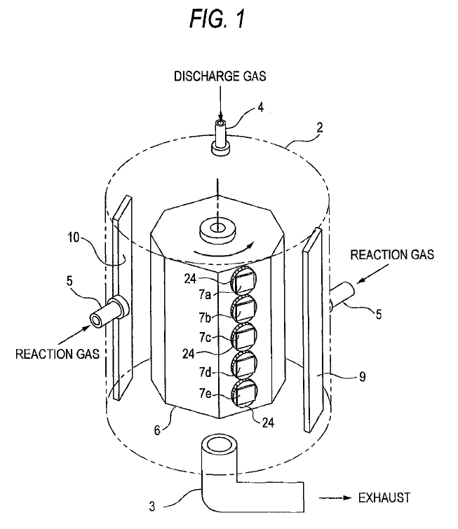

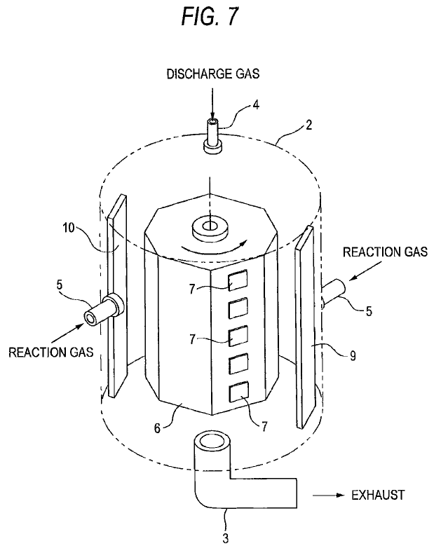

A retardation compensation element of the invention is manufactured by, for example, a sputtering device shown in FIG. 1. The sputtering device has basically the same structure as the device shown of the related art shown in FIG. 7, except that a mechanism for rotating a substrate 7 about its normal line is provided in a drum 6 that supports the substrate 7. Also, the drum 6 is provided with rotatable substrate holders 24 on the outer peripheral surface, and five substrates 7a to 7e are supported by the substrate holders 24. The substrates 7a to 7e can be rotated 90 degrees about those normal lines by rotating the substrate holders 24 90 degrees. The rotation direction of 90 degrees may be any one of a clockwise direction and a counterclockwise direction.

The other configuration of the sputtering device is the same as the device of the related art shown in FIG. 7. Nb that is a source material of a Nb₂O₅ film having a high refractive index is used as the target material 9, and Si that is a source material of a SiO₂ film having a low refractive index is used as the target material 10. Vertical sizes of the target materials 9, 10 are larger than a vertical size of the drum 6 so that the film formation condition is not extremely changed for the substrate 7a of the first stage and the substrate 7e of the fifth stage.

First, air in the vacuum chamber 2 is discharged before film formation. When the air is discharged to a predetermined vacuum degree, argon gas serving as discharge gas is introduced from the inlet nozzle 4, which is an inlet of discharge gas while the air is being discharged. Thus, the vacuum chamber 2 is filled with the argon gas at a specified gas pressure. When a voltage is applied to the target materials 9, 10, argon gas plasma is generated between the drum 6 and the target materials 9, 10.

In this state, oxygen gas is introduced from inlet nozzles 5, 5 which are inlets of reaction gas, and the oxygen gas is added in the argon gas plasma. When the drum 6 is rotated at a constant speed, the sputtering process is performed while the substrates 7a to 7e pass through sputtering areas that face the target materials 9, 10. In this case, Nb particles and Si particles released from the respective target materials 9, 10 are oxidized in the oxygen atmosphere, change into Nb₂O₅ and SiO₂, and are sequentially deposited on the substrates 7a to 7e. As a result, the high refractive index films made of Nb₂O₅ and the low refractive index films made of SiO₂ are formed alternately. Thicknesses of the thin layers may be controlled by adjusting the rotation speed of the drum 6, adjusting the discharge voltage/discharge power, and adjusting open and close time of a shutter which may be provided between the target materials and the drum. Also, in the case where the shutter is provided, the drum 6 may be stopped when the substrates 7a to 7e arrive in the sputtering areas, and in that state, the shutter may be controlled to open and close. By using this method, it is possible to alternately stack the high refractive index film and the low refractive index film on the substrate with desired thicknesses.

Other than the oxide films, it is also possible to use various materials as the target materials 9, 10 in accordance with a magnitude of the retardation dΔn generated by the liquid crystal layer. For example, it is suitable use an oxide film such as a TiO₂ film, a ZrO₂ film, a CeO₂ film, a SnO₂ film, and a Ta₂O₅ film, as high refractive thin layers in view of good film strength and small light absorption. Also, it is suitable to use an oxide film such as an Al₂O₃ film and a MgO film, as the low refractive thin layers. In order to form such the oxide films, the films may be formed while introducing the oxygen gas to the sputtering area as described above to oxide the films. Alternatively, the oxide film may be formed by performing the sputtering process for the substrate using the target materials 9, and only argon gas and without introducing the oxygen gas to the sputtering areas, and by passing the sputtered substrate through oxidizing areas filled with the oxygen gas before a thin layer of the next layer is formed.

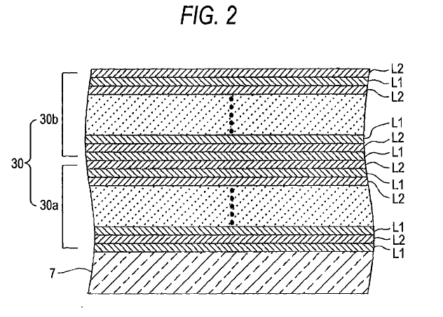

It is assumed that a retardation compensation layer is formed as a multilayer structure including 200 layers in total by alternately stacking 100 layers of the high refractive index film and 100 layers of the low refractive index film with a given thickness. In this case, the substrate holder 24 is simultaneously rotated 90 degrees at the time point when 100 layers in total are formed on the substrates 7a to 7e. Then, the remaining 100 layers are formed in the same manner as described above. FIG. 2 is a schematic view illustrating the configuration of the retardation compensation layer 30 stacked on the substrate 7 in this manner. The retardation compensation layer 30 having the 200 layers in total includes: a first unit layer 30a having 100 layers in which a high refractive index film L1 and a low refractive index film L2 are alternately stacked; and a second unit layer 30b having 100 layers in which the high refractive index film L1 and the low refractive index film L2 are alternately stacked in the same manner.

The first unit layer 30a and the second unit layer 30b have the same configuration. However, the substrate 7 is rotated 90 degrees with respect to the target materials 9, 10 at the boundary between the first unit layer 30a and the second unit layer 30b. Thus, when the first unit layer 30a has physical properties having directivity caused by slight difference of the film formation conditions, particularly, distribution characteristic of retardation dΔn for azimuth angles of the incident ray being biased, the second unit layer 30b functions so as to complementarily adjust the bias thereof.

Specifically, the value of the retardation dΔn of the retardation compensation layer 30 is determined by the birefringence Δn and the total film thickness d. Thus, it is expected that the film thickness and the refractive index are not always uniformly formed by the slight bias of the film formation condition at the time of forming the high refractive index film L1 and the low refractive index film L2. However, the substrate 7 is rotated 90 degrees at the time when the first unit layer 30a has been formed as described above, and then the second unit layer 30b having the same film configuration is stacked. Therefore, bias caused by the difference of the film formation conditions is corrected as a whole, and so it is possible to obtain good retardation compensation effect.

The film thicknesses of the high refractive index film L1 and the low refractive index film L2 are very thin as compared with a general optical interference thin layer. For example, for visible light (reference wavelength is 550 nm), the optical film thicknesses of them are in a range of λ/100 to λ/5, preferably in a range of λ/50 to λ/5, and more preferably in a range of λ/30 to λ/10. Accordingly, even if the boundary between the first unit layer 30a and the second unit layer 30b shifts from a portion between 100th layer and 101st layer as much as several layers, the significant difference is not caused. However, it is preferable that the first unit layer 30a is set up to the 100th layer, the second unit layer 30b is set in the range of 101^{st} or more layers. Thereby, the unit layers 30a and 30b are formed to have the same multilayer film structure.

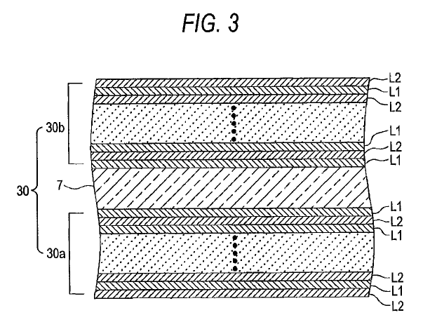

FIG. 3 is a view illustrating a retardation compensation element in which the first unit layer 30a and the second unit layer 30b are formed on the front and back surfaces of the substrate 7. In order to manufacture this retardation compensation element, the first unit layer 30a is formed while one surface of the substrate 7 is caused to face the target materials 9, 10 and then, the second unit layer 30b is formed by (i) inverting the front and back of the substrate 7 so that the other surface of the substrate 7 faces the target materials 9, 10, (ii) rotating the substrate 7 90 degrees about the normal line of the substrate and (iii) stacking films in the same manner as the film formation process of the first unit layer 30a.

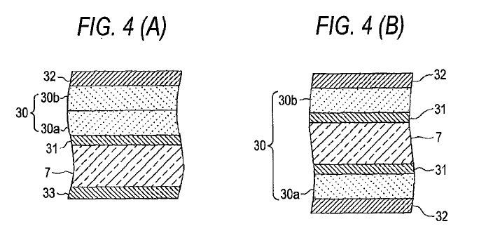

FIG. 4 is a view illustrating exemplary retardation compensation elements to which antireflection layers are added. In FIG. 4(A), the antireflection layers 31, 32, and 33 are added in the retardation compensation element. The antireflection layer 31 prevents interfacial reflection between the substrate 7 and the retardation compensation layer 30. The antireflection layer 32 prevents interfacial reflection between air and the retardation compensation layer 30. The antireflection layer 33 prevents interfacial reflection between the substrate 7 and air. Of these antireflection layers, for example, the antireflection layer 33 may be configured so that the low refractive index film L2 is formed with a film thickness of λ/4, and the antireflection layers 31 and 32 may be configured of a multi-antireflection layer in which the high refractive index film L1 and the low refractive index film L2 are combined so as to have film thicknesses that constitute interferential thin layers.

FIG. 4(B) illustrates an example of a combination of the antireflection layers and the retardation compensation element shown in FIG. 3. The antireflection layers 31 and 32 used in FIG. 4(A) are combined as shown in the drawing, and thus it is possible to prevent reflection at the retardation compensation element. All the antireflection layers may be formed before and after the film formation process of the retardation compensation layer 30. Therefore, it is not necessary for the vacuum chamber to be brought to be the air pressure, and the manufacturing efficiency is not deteriorated.

### EXAMPLE

Hereinafter, specific examples of the retardation compensation element according to the invention will be described. The retardation compensation layer 30 having the multilayer structure shown in FIG. 4(A) was basically formed using a sputtering device that principally had the configuration shown in FIG. 1. The substrates 7a to 7e were arranged in a column direction and supported on the drum 6. Then, Nb₂O₅ film serving as the high refractive index film L1 and SiO₂ film serving as the low refractive index film L2 were alternately stacked on the substrates 7a to 7e. The following Table 1 represents an example of the specific film configuration. The first layer and the second layer on the substrate side correspond to the antireflection layer 31, and four layers of the 175th layer to the 178th layer on the top-layer side correspond to the antireflection layer 32. The antireflection layer of the rear-surface side of the substrate 7 is omitted, but practically it is preferable to provide an antireflection layer including a multilayer film having four to six layers.

TABLE 1

| Layer | Type of | Refractive | Physical |
|---|---|---|---|
| No. | Thin layer | Index | Thickness (nm) |
| | Air | 1 | |
| 178 | SiO₂ | 1.4794 | 95.48 |
| 177 | Nb₂O₅ | 2.3796 | 50.47 |
| 176 | SiO₂ | 1.4794 | 12.49 |
| 175 | Nb₂O₅ | 2.3796 | 45.81 |
| 174 | SiO₂ | 1.4794 | 15.0 |
| 173 | Nb₂O₅ | 2.3796 | 15.0 |
| 172 | SiO₂ | 1.4794 | 15.0 |
| 171 | Nb₂O₅ | 2.3796 | 15.0 |
| 170 | SiO₂ | 1.4794 | 15.0 |
| 90 | SiO₂ | 1.4794 | 15.0 |
| 89 | Nb₂O₅ | 2.3796 | 15.0 |
| 88 | SiO₂ | 1.4794 | 15.0 |
| 87 | Nb₂O₅ | 2.3796 | 15.0 |
| 86 | SiO₂ | 1.4794 | 15.0 |
| 85 | Nb₂O₅ | 2.3796 | 15.0 |
| 84 | SiO₂ | 1.4794 | 15.0 |
| 83 | Nb₂O₅ | 2.3796 | 15.0 |
| 82 | SiO₂ | 1.4794 | 15.0 |
| 7 | Nb₂O₅ | 2.3796 | 15.0 |
| 6 | SiO₂ | 1.4794 | 15.0 |
| 5 | Nb₂O₅ | 2.3796 | 15.0 |
| 4 | SiO₂ | 1.4794 | 15.0 |
| 3 | Nb₂O₅ | 2.3796 | 15.0 |
| 2 | SiO₂ | 1.4794 | 39.71 |
| 1 | Nb₂O₅ | 2.3796 | 11.68 |
| | Substrate (glass) | 1.5208 | |

The retardation compensation layer 30 was formed of 172 layers in total from the 3rd layer to the 174th layer, and Nb₂O₅ films and SiO₂ films were alternately stacked with a thickness of 15 nm. The first unit layer 30a, on the substrate side, forming the retardation compensation layer 30 was formed of 86 layers in total from the 3rd layer to the 88th layer, and the second unit layer 30b further stacked thereon was formed of 86 layers in total from the 89th layer to the 174th layer. After the first unit layer 30a was formed, the substrate 7 was rotated 90 degrees in the clockwise direction on the drum 6, and then the second unit layer 30b was formed, thereby manufacturing samples (1) to (5) of the retardation compensation element according to the invention. Also, for comparison, the retardation compensation layer 30 of the 3rd layer to the 174th layer was formed in series without rotating the substrate 7, and thus comparison samples (1) to (5) were manufactured. The respective samples (1) to (5) are based on substrate positions on the drum 6. The sample formed on the substrate 7a of the first stage is referred to as (1), and the sample formed on the substrate 7b of the second stage, the sample formed on the substrate 7c of the third stage, the sample formed on the substrate 7d of the fourth stage, and the sample formed on the substrate 7e of the fifth stage are sequentially referred to as (2), (3), (4), and (5).

All the physical film thicknesses of the antireflection layers 31 and 32 and the retardation compensation layer 30 are not values obtained by actually measuring or analyzing the samples after the film formation but the set film thicknesses in the film formation. Also, the physical film thicknesses are estimated based on set film formation conditions such as the rotation speed of the drum 6 and the discharge voltage/discharge power applied to the target materials 9, 10, and well coincide with film thicknesses that are measured while film formation is performed. Also, the respective refractive indices of the thin layers were previously checked in a preliminary film-formation experiment in a similar manner, and were not actual measured values obtained by measuring the respective layers of the manufactured retardation compensation layer 30 per se.

TABLE 2

| | | Retardation for Incident Angle (θ) of 30 degs. (λ = 550 nm) | | | | | | | | | |
|---|---|---|---|---|---|---|---|---|---|---|---|
| | | Comparative Samples | | | | | Samples of Invention | | | | |
| | | \textcircled{1} | \textcircled{2} | \textcircled{3} | \textcircled{4} | \textcircled{5} | \textcircled{1} | \textcircled{2} | \textcircled{3} | \textcircled{4} | \textcircled{5} |
| Azimuth Angle | 0° | 37.25 | 35.18 | 34.92 | 35.63 | 37.47 | 35.27 | 34.82 | 35.03 | 35.11 | 35.47 |
| | 30° | 36.44 | 35.16 | 35.08 | 35.60 | 37.05 | 35.40 | 34.85 | 34.97 | 35.12 | 35.51 |
| | 60° | 34.56 | 35.05 | 35.31 | 35.25 | 34.47 | 35.55 | 34.97 | 35.30 | 35.43 | 35.60 |
| | 90° | 33.83 | 34.93 | 35.45 | 35.28 | 33.95 | 35.60 | 34.99 | 35.19 | 35.55 | 35.70 |
| | 120° | 34.38 | 34.91 | 35.27 | 35.39 | 34.42 | 35.59 | 34.87 | 34.83 | 35.50 | 35.70 |
| | 150° | 36.49 | 35.11 | 35.12 | 35.58 | 36.85 | 35.41 | 34.84 | 34.90 | 35.22 | 35.68 |
| | 180° | 37.33 | 35.23 | 34.97 | 35.63 | 37.51 | 35.26 | 34.80 | 34.89 | 35.06 | 35.60 |
| | 210° | 36.50 | 35.18 | 35.05 | 35.56 | 36.74 | 35.32 | 34.82 | 34.97 | 35.24 | 35.60 |
| | 240° | 34.40 | 34.88 | 35.37 | 35.45 | 34.76 | 35.45 | 34.86 | 35.12 | 35.40 | 35.74 |
| | 270° | 33.68 | 34.79 | 35.38 | 35.29 | 34.10 | 35.50 | 34.98 | 35.08 | 35.51 | 35.76 |
| | 300° | 34.55 | 34.91 | 35.31 | 35.29 | 34.75 | 35.54 | 34.94 | 35.11 | 35.50 | 35.73 |
| | 330° | 36.37 | 35.06 | 35.14 | 35.54 | 36.81 | 35.26 | 34.77 | 35.01 | 35.26 | 35.60 |

| | | | | | | | | | | |
|---|---|---|---|---|---|---|---|---|---|---|
| MAX | 37.33 | 35.23 | 35.45 | 35.63 | 37.51 | 35.60 | 34.99 | 35.30 | 35.55 | 35.76 |
| MIN | 33.68 | 34.79 | 34.92 | 35.25 | 33.95 | 35.26 | 34.77 | 34.83 | 35.06 | 35.47 |
| MAX − MIN | 3.64 | 0.44 | 0.53 | 0.38 | 3.56 | 0.35 | 0.22 | 0.48 | 0.49 | 0.29 |
| Average | 35.48 | 35.03 | 35.20 | 35.46 | 35.74 | 35.43 | 34.87 | 35.03 | 35.33 | 35.64 |
| σ | 1.36 | 0.14 | 0.17 | 0.15 | 1.43 | 0.13 | 0.08 | 0.14 | 0.18 | 0.09 |

Table 2 described above shows measured values of the retardation dΔn when light having a wavelength of 550 nm is incident at an angle of 30 degrees on the manufactured comparison samples and the samples of the invention. The measurement was performed with the azimuth angle being changed 30 degrees by 30 degrees. Even if the substrates 7a to 7e are vertically arranged on the drum 6 and general optical interference thin layers are formed thereon in the same manner, significant difference thereamong according to the substrate positions hardly appears. Conversely, as particularly remarkable in the comparison samples (1) and (5), there is such a difference therebetween that values of retardation dΔn certainly depends on the azimuth angle.

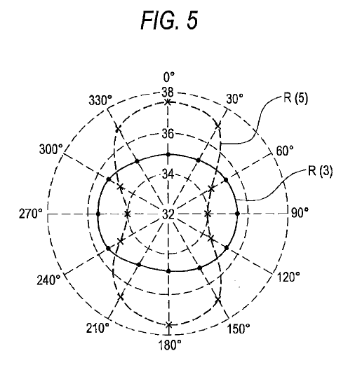

FIG. 5 is a graph representing the values of the retardation dΔn of the comparison samples (3) and (5) shown in Table 2. A length of radius corresponds to a value of retardation. The comparison sample (3), that is, retardation R(3) of the retardation compensation layer of the substrate 7c located on the middle of the drum 6 in a height direction had no extreme bias depending on the azimuth angle when a ray is incident at an angle of 30 degrees. However, the comparison sample (5), that is, retardation R(5) of the retardation compensation layer of the substrate 7e located on the fifth stage of the drum 6 was remarkably changed certainly depending on the azimuth angle. As shown in Table 2, the comparison sample (1) in which the retardation compensation layer was formed on the substrate 7a located on the first stage had substantially the same trends as the comparison sample (5). Also, a graph showing retardation of the comparison samples (2) and (4) was omitted, but the graph was similar to the characteristic of the comparison sample (3).

From the observation described above, in the case where the film formation method shown in FIG. 1 is employed, it is found that film formation conditions, such as sizes and positions of the target materials 9, 10 and non-uniformity of oxygen density caused by positions of the inlet nozzles 5, 5 of the oxygen gas, are not uniform in strict view at the time when the thin layers are deposited on the substrates 7a to 7e. Accordingly, even in the case where the retardation compensation element is manufactured by simply stacking the retardation compensation layer 30 on the substrates 7a to 7e that are fixed on the drum 6 as in the related art, the samples (2) to (4) may be commercialized as products without problems. However, in the case where the retardation compensation effect of high accuracy independent of azimuth angles is required, there is a possibility that the samples (1) and (5) may not be commercialized as products.

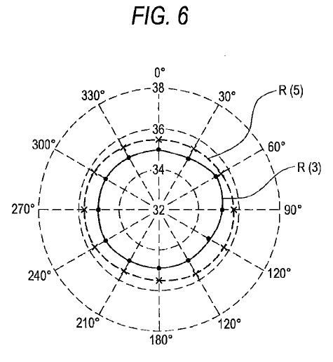

To the contrary, the samples (1) to (5) of the invention are manufactured by rotating the substrate by 90 degrees at the time point when the retardation compensation layer has been formed up to an intermediate portion of the retardation compensation layer, that is, up to the first unit layer and by subsequently forming the second unit layer. In the samples (1) to (5) of the invention, particularly, in the samples (3) and (5) as shown in FIG. 6, the retardation R(3) of the retardation compensation layer formed on the substrate 7c and the retardation R(5) of the retardation compensation layer formed on the substrate 7e hardly fluctuate depending on the azimuth angle. Therefore it is possible to obtain good retardation compensation effect. Accordingly, it can be found that any of the samples is commercialized as a product. Also, as noted in Table 2, when the maximum value (MAX), the minimum value (MIN), a difference between the maximum value and the minimum value, an average value (Average), and a standard bias (a) of the retardation values at the respective azimuth angles in the samples (1) to (5) are estimated, it is found that the samples of the invention have the retardation compensation effect having no bias rather than the comparison samples.

Also, the retardation for the vertical incident light (having the incident angle θ of 0 degrees) is independent of the azimuth angles. However, there is a deference between the comparison samples (1) to (5) and the samples (1) to (5) of the invention as shown in the following Table 3. In the comparison samples (1) and (5), retardation larger than 1 nm occurs in the vertical incident light, while in the samples (1) to (5) of the invention, retardation less than 0.2 nm occurs. Therefore, the excellent characteristic of the samples of the invention is confirmed.

TABLE 3

Retardation at the time of Vertical Incidence (nm)

| | Comparative Samples | Samples of the Invention |
|---|---|---|
| \textcircled{1} | 1.83 | −0.06 |
| \textcircled{2} | 0.24 | −0.07 |
| \textcircled{3} | −0.22 | −0.04 |
| \textcircled{4} | 0.21 | −0.14 |
| \textcircled{5} | 1.74 | −0.04 |

As described above, the retardation compensation element according to the invention obtains the retardation compensation effect using the retardation compensation layer formed by alternately stacking the high refractive index film and the low refractive index film as much as several tens of layers to one hundred several tens of layers or to several hundreds of layers. It is premised on that gradually accumulated is a bias of physical properties such as birefringent index and a film thickness, which are caused by non-uniformity of the film formation conditions that cannot be accurately controlled at the time of forming the respective thin layers and that finally, the bias of the physical properties increases to the extent that cannot be neglected. Therefore, the substrate is rotated 90 degrees about the normal line of the substrate in the course of the film formation process, and thereafter, the film formation process is continued in the same manner as the previous film formation process. Thus, the bias of the physical properties is complementarily solved, and so the physical properties of the entire retardation compensation layer are kept at a good level as a whole. This method has a highly practical merit in that this method can be applied even if slight difference in the film formation conditions and change in the physical property values caused by such difference are not known as a fixed quantity. Also, this method is not limited to the general sputtering method, but can be applied to various film formation methods such as a deposition method and an ion plating method.

Also, in order to perform the invention, the number of stacked layers, film thicknesses, and refractive indices of the thin layers constituting the retardation compensation layer are not limited to the aforementioned examples but may be modified in accordance with a type of a liquid crystal layer, which is used in a liquid crystal panel. In addition, the invention may be applied to a retardation compensation element that is used in combination with, for example, a reflective-type liquid crystal panel. In this case, generally, the retardation compensation element is disposed between a light incident surface of the liquid crystal layer and a polarizing plate. Alternatively, the retardation compensation element may be disposed on the rear-surface side of the liquid crystal layer, that is, the reflective-surface side. Particularly, when the retardation compensation layer is formed on the reflective surface, a substrate of a retardation compensation element may be opaque. The substrate of the retardation compensation element is not limited to a transparent substrate.

As to the film configuration of the retardation compensation layer, it is preferable to use the film configuration that two types of thin layers having a high refractive index and a low refractive index are alternately formed with the same physical film thickness as described in the embodiments mentioned above, in order to simplify the fabrication processes. However, the number of types of thin layers having different refractive indices from each other also may be changed to three or more. Also, the respective film thicknesses may be changed. In addition, practically, it is preferable to provide several antireflection layers on boundaries among a substrate, a retardation compensation layer, and air. Furthermore, it is preferable that the thin layers forming the antireflection layer use the same thin-film material as the material used to form the retardation compensation layer. However, a dedicated thin-film material such as a MgF2 film that is often and stably used as a low refractive index material may be in at least a part of the thin layers constituting the antireflection layer. It should also be noted that these antireflection layers may be omitted if it is only intended to obtain the retardation compensation effect.

What is claimed is:

1. A retardation compensation element for generating negative retardation in incident ray in accordance with an incident angle of the incident ray, the retardation compensation element comprising:
a substrate; and
a retardation compensation layer including
a first unit layer having a multilayer structure in which at least two types of thin layers that have difference refractive indices from each other are stacked on the substrate, and
a second unit layer having a multilayer structure in which the at least two types of thin layers are stacked on the first unit layer, and
a retardation distribution characteristic of the first unit layer for azimuth angles of the incident ray is substantially perpendicular to a retardation distribution characteristic of the second unit layer for the azimuth angles of the incident ray.

2. The retardation compensation element according to claim 1, wherein the multilayer structure of the first unit layer has substantially the same film configuration as the multilayer structure of the second unit layer.

3. The retardation compensation element according to claim 2, wherein at least one of the two types of thin layers, which form the first unit layer and the second unit layer, is an oxide film formed in an oxidation atmosphere or an oxide film oxidized by exposure to an oxygen atmosphere after film formation.

4. A retardation compensation element for generating negative retardation in incident ray in accordance with an incident angle of the incident ray, the retardation compensation element comprising:
a transparent substrate;
a retardation compensation layer including
a first unit layer having a multilayer structure in which at least two types of thin layers that have difference refractive indices from each other are alternately stacked on one of surfaces of the transparent substrate, and
a second unit layer having a multilayer structure in which the at least two types of thin layers are stacked on the other surface of the first unit layer, and
a retardation distribution characteristic of the first unit layer for azimuth angles of the incident ray is substantially perpendicular to a retardation distribution characteristic of the second unit layer for the azimuth angles of the incident ray.

5. The retardation compensation element according to claim 4, wherein the multilayer structure of the first unit layer has substantially the same film configuration as the multilayer structure of the second unit layer.

6. The retardation compensation element according to claim 5, wherein at least one of the two types of thin layers, which form the first unit layer and the second unit layer, is an oxide film formed in an oxidation atmosphere or an oxide film oxidized by exposure to an oxygen atmosphere after film formation.

7. A method of manufacturing a retardation compensation element that generates negative retardation in incident ray passing through a retardation compensation layer of the retardation compensation element in accordance with an incident angle of the incident ray, the method comprising:
providing a substrate and at least two types of thin-film materials in a vacuum chamber; and
depositing particles on the substrate by releasing the particles in order from the thin-film materials, to form the retardation compensation layer having a multilayer structure in which at least two types of thin layers having different refractive indices from each other are stacked on the substrate, wherein
the depositing of the thin-film materials includes
forming a first unit layer by stacking the at least two types of thin layers up to an intermediate portion of the retardation compensation layer,
thereafter, rotating the substrate 90 degrees about a normal line of the substrate, and
then, forming a second unit layer that works with the first unit layer to constitute the retardation compensation layer, by stacking the at least two types of thin layers.

8. The method according to claim 7, wherein the multilayer structure of the first unit layer has substantially the same film configuration as the multilayer structure of the second unit layer.

9. The method according to claim 8, wherein at least one of the two types of thin layers, which form the first unit layer and the second unit layer, is an oxide film formed in an oxidation atmosphere or an oxide film oxidized by exposure to an oxygen atmosphere after film formation.

10. The method claim 7, wherein the two types of thin layers forming the first and second unit layer are deposited by sputtering.

11. The method claim 8, wherein the two types of thin layers forming the first and second unit layer are deposited by sputtering.

12. The method claim 9, wherein the two types of thin layers forming the first and second unit layer are deposited by sputtering.

13. A method of manufacturing a retardation compensation element that generates negative retardation in incident ray passing through a retardation compensation layer of the retardation compensation element in accordance with an incident angle of the incident ray, the method comprising:
providing a substrate and at least two types of thin-film materials in a vacuum chamber; and
depositing particles on the substrate by releasing the particles from the respective thin-film materials separately, to form the retardation compensation layer having a multilayer structure in which at least two types of thin layers having different refractive indices from each other are stacked on the substrate, wherein
the depositing of the thin-film materials includes
forming a first unit layer on one of surfaces of the substrate by stacking the at least two types of thin layers up to an intermediate portion of the retardation compensation layer,
thereafter, rotating the substrate 90 degrees about a normal line of the substrate and inverting the substrate, and
forming a second unit layer that works with the first unit layer to constitute the retardation compensation layer, by stacking the at least two types of thin layers.

14. The method according to claim 13, wherein the multilayer structure of the first unit layer has substantially the same film configuration as the multilayer structure of the second unit layer.

15. The method according to claim 14, wherein at least one of the two types of thin layers, which form the first unit layer and the second unit layer, is an oxide film formed in an oxidation atmosphere or an oxide film oxidized by exposure to an oxygen atmosphere after film formation.

16. The method claim 13, wherein the two types of thin layers forming the first and second unit layer are deposited by sputtering.

17. The method claim 14, wherein the two types of thin layers forming the first and second unit layer are deposited by sputtering.

18. The method claim 15, wherein the two types of thin layers forming the first and second unit layer are deposited by sputtering.
